(19) United States
(12) Patent Application Publication
(10) Pub. No.: US 2025/0284081 A1
(43) Pub. Date: Sep. 11, 2025

(54) DOME-TYPE MECHANICAL OPTICAL CABLE JUNCTION BOX

(71) Applicant: SUNIL TELECOM CO., LTD., Gwangju (KR)

(72) Inventor: Yeon Ji Kim, Gwangju (KR)

(21) Appl. No.: 18/855,824

(22) PCT Filed: Mar. 27, 2023
(86) PCT No.: PCT/KR2023/004040

§ 371 Date: Oct. 10, 2024

(30) Foreign Application Priority Data
Apr. 13, 2022 (KR) 10-2022-0045960

(51) Int. Cl. G02B 6/44

(52) U.S. Cl. CPC G02B 6/44465; G02B 6/4447

(57) ABSTRACT

The dome-type mechanical optical cable junction box of the present invention includes a base member including a support frame on which splice trays for connecting optical cables are installed, and a plurality of mounting parts through which cables pass for cable entry and exit, supporting the support frame; a cover member coupled to the base member, enclosing the support frame to maintain airtightness; and a sealing unit coupled to each mounting part of the base member, encasing the cable, maintaining air-tightness with the exterior, and having at least one cable fixing part fixing the cable.

### TECHNICAL FIELD

The present invention relates to an optical cable junction box, and more specifically, to a dome-type mechanical optical cable junction box with improved sealing at the cable inlet and outlet sections and an enhanced cable fixing structure.

### BACKGROUND ART

In general, optical cables are used as a means of transmitting optical signals and, unlike cables transmitting electrical signals, can transmit a large amount of information quickly without loss. Optical cables are composed of clusters of multiple optical cables, and each optical cable cluster consists of a bundle of optical fibers.

Since such optical cables cannot be manufactured infinitely long, they are produced in predetermined lengths and wound onto drums, requiring interconnection between optical cables for installation.

As such, an optical cable junction box is used to connect or branch optical cables.

Meanwhile, when connecting optical cables, the cable is introduced into the junction box, and a cable fixing means is provided to protect the connection portion from the tension acting on the optical cable. Furthermore, when installed outdoors or underground, a water-tight means is provided to prevent moisture from entering the junction box.

Korean Patent Publication No. 2021-0062328 (published on May 31, 2021) discloses an optical junction box.

The disclosed optical junction box includes a cover with an internal accommodating space; a base mounted at the bottom of the cover; a sealing member interposed at the mounting part formed on the base and through which the optical cable is inserted or extracted; and pressure plates provided on both opposing sides of the sealing member to increase the cross-sectional area within the mounting part.

Korean Patent No. 0233344 discloses a sealing device for a cable connection part. The disclosed sealing device has a structure equipped with a sealing ring that can be closely attached to the outer circumference of the cable by moving the internal elements through a sealing plate that can be coupled to one end of the cable connection sleeve.

While the conventional junction boxes structured as described above can improve the sealing force with the cable, they have relatively weak support force for the cable.

Korean Patent Publication No. 2014-0025789 discloses a mid-span branching junction box. The disclosed junction box has a structure that allows clamping of a mid-span optical cable branching from one side of the body at the inlet section using a gland type that tightly presses the cable without a heat-shrink method.

EP Patent No. 2136118 discloses a device for sealing optical cables passing through a container for optical fibers, and EP Patent No. 2136118 discloses a device for passing a conduit through a wall.

### DETAILED DESCRIPTION OF THE INVENTION

### Technical Problems

The present invention is designed to solve the problems of the prior art mentioned above and provides a dome-type mechanical optical cable junction box equipped with sealing units that enhance the fixing force and water-tightness of the optical cables by utilizing the shape deformation of sealing members installed at the mounting parts for the entry and exit of optical cables.

Another objective of the present invention is to provide a dome-type mechanical optical cable junction box that improves the fixing force of optical cables to protect the connection parts using splice trays, improves the workability related to coupling and decoupling the cables for sealing, and increases water-tightness and cable support force by flexibly adapting to changes in cable diameter.

Yet another objective of the present invention is to provide a dome-type mechanical optical cable junction box that prevents the cable from detaching from the mounting part of the base member due to external forces acting on the cable, as it supports the cable through first and second pressing members formed at least on one side of the sealing unit.

### Technical Solution

To achieve the objectives, the dome-type mechanical optical cable junction box of the present invention is characterized by including: a base member including a support frame on which splice trays for connecting optical cables are installed, and a plurality of mounting parts through which cables pass for cable entry and exit, supporting the support frame; a cover member coupled to the base member, enclosing the support frame to maintain airtightness; and a sealing unit coupled to each mounting part of the base member, encasing the cable, maintaining air-tightness with the exterior, and having at least one cable fixing part fixing the cable.

In this invention, the sealing unit is inserted into the mounting part of the base member and may include: a first pressing member having a first coupling part to maintain an interlocking state and including first and second unit pressing members forming at least one first cable insertion hole; a second pressing member having a second coupling part to maintain an interlocking state and including third and fourth unit pressing members forming at least one second cable insertion hole; a sealing member interposed between the first and second pressing members, with cable gripping holes formed corresponding to the first and second cable insertion holes; and a fastening unit that presses the first and second pressing members toward the sealing member, causing the sealing member to be deformed and closely adhere to the outer circumference of the cable and the inner circumference of the mounting part.

The first coupling part may comprise a first projection support formed by drawing in from the top surface of the first unit pressing member, a first coupling projection extending from the side of the first unit pressing member, a second projection support formed by drawing in from the bottom surface of the second unit pressing member, and a second coupling projection extending from the side of the second unit pressing member;

The second coupling part may comprise a third projection support formed by drawing in from the top surface of the third unit pressing member, a third coupling projection extending from the side of the third unit pressing member, a fourth projection support formed by drawing in from the bottom surface of the fourth unit pressing member, and a fourth coupling projection extending from the side of the fourth unit pressing member.

The cable fixing part may include a tensile wire fixing part installed in the first pressing member to secure the tensile wire of the cable. The tensile wire fixing part may comprise a cable support bracket installed on the first pressing member and having multiple coupling support portions, a tensile wire gripping member inserted in the coupling support portion of the cable support bracket and having a tensile wire insertion portion for the cable, and a fixing member screw-coupled to the tensile wire gripping member to secure the coupling support portion and the tensile wire.

A protruding anti-detachment ridge may be formed on the inner circumference of the mounting part corresponding to the inserted sealing member to prevent the sealing unit from detaching,

The base member installed in the mounting part may be further provided with a sealing unit detachment prevention part to prevent the detachment of the sealing unit inserted into the mounting part.

The sealing unit detachment prevention part may include set screws, which are screw-coupled to the base member around the mounting part, and a portion of the head of the set screws is in close contact with the bottom edge of the second pressing member to prevent the detachment of the sealing unit.

### BRIEF DESCRIPTION OF THE DRAWINGS

FIG. 1 is an exploded perspective view of a dome-type mechanical optical cable junction box according to the present invention.

FIG. 2 is an exploded perspective view of the base member and sealing unit of the dome-type mechanical optical cable junction box according to the present invention.

FIG. 3 is an exploded perspective view of the sealing unit shown in FIG. 1 and FIG. 2.

FIG. 4 is a perspective view illustrating a state in which the optical cable is fixed by the cable fixing part of the dome-type mechanical optical cable junction box according to the present invention.

FIG. 5 is an exploded perspective view of another embodiment of the sealing unit of the dome-type mechanical optical cable junction box according to the present invention.

FIG. 6 is a perspective view showing a sealing unit detachment prevention part for preventing the detachment of the sealing unit of the dome-type mechanical optical cable junction box according to the present invention.

FIG. 7 is a cross-sectional view of the sealing unit coupled to the mounting part of the dome- type mechanical optical cable junction box according to the present invention.

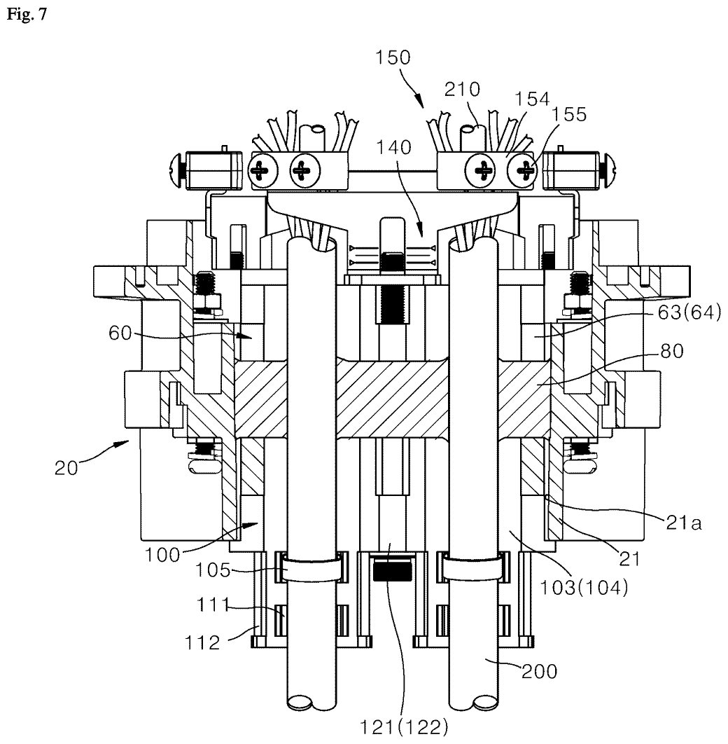

FIG. 8 is a cross-sectional view illustrating another embodiment of the sealing unit coupled to the mounting part of the dome-type mechanical optical cable junction box according to the present invention.

### BEST MODE OF THE INVENTION

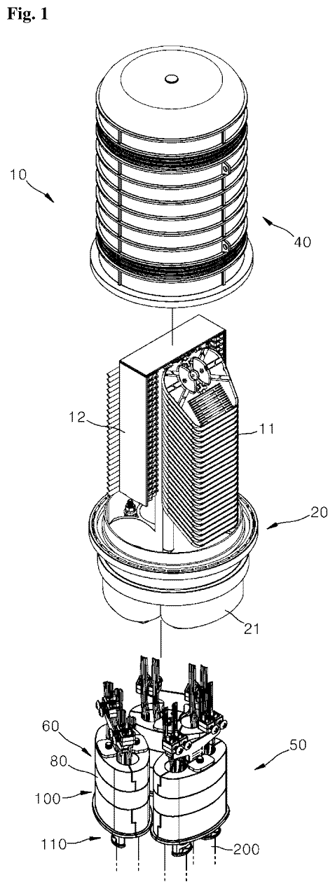

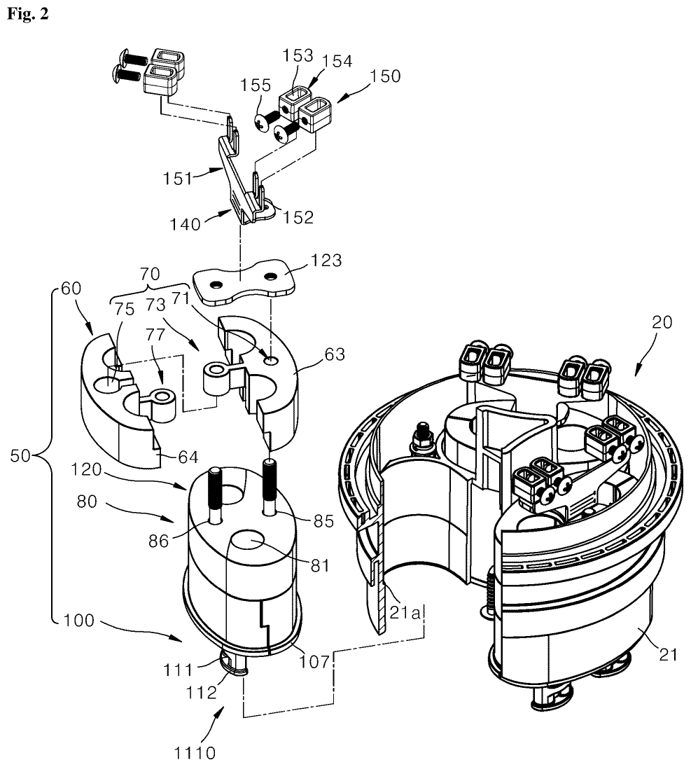

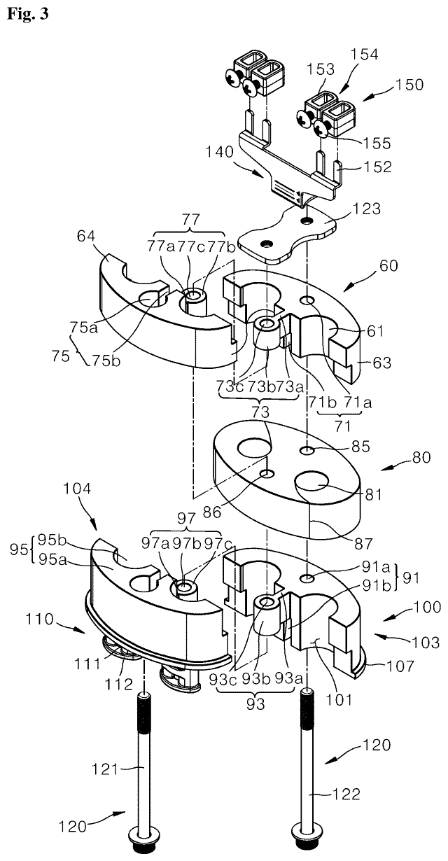

An embodiment of a dome-type mechanical optical cable junction box according to the present invention is shown in FIGS. 1 to 4.

Referring to the drawings, the dome-type mechanical optical cable junction box (10) according to the present invention includes a base member (20), a cover (40) that is coupled to the base member (20) and encloses a space where splice trays for connecting optical cables are mounted, and a sealing unit (50) that is installed in the mounting part (21) of the base member (20) to maintain water-tightness between the optical cable (200) being inserted or extracted and the mounting part (21).

The components of the dome-type mechanical optical cable junction box (10) according to the present invention, constructed as described above, are explained in more detail as follows.

A support frame (12) on which splice trays (11) for connecting optical fibers branched from the optical cable (200) are installed, is provided on the upper surface of the base member (20). The base member (20) is provided with a plurality of mounting parts (21) for the entry and exit of the optical cable (200). The mounting parts (21) are arranged in parallel so that they pass through the base member (20), and are formed in an elliptical shape in cross-section. Ribs are formed between the mounting parts (21) of the base member (20), and these ribs can be interconnected.

The cover (40) is coupled to the base member (20) and encloses the support frame (12) with the splice trays (11) installed, thereby partitioning a sealed space. The coupling between the cover (40) and the base member (20) can be achieved by means of toggle clamps or set screws, with packing interposed in the coupling area. Additionally, a separate ring member may be installed on the outer surface of the cover (40) to suspend the junction box.

The sealing unit (50) is mounted in the mounting parts (21) formed in the base member (20) to support the optical cable (200) and maintain water-tightness between the outer surface of the optical cable (200) and the inner surface of the mounting parts (21) as the optical cable (200) enters or exits the internal space enclosed by the cover (40) and base member (20).

As shown in FIGS. 1 to 3, the sealing unit (50) is inserted into the mounting part (21) formed in the base member (20) while supporting the optical cable (200), and includes first and second pressing members (60)(100) that have the same shape as the hollow part (21a) of the mounting part (21). The sealing unit includes a sealing member (80) installed between the first and second pressing members (60)(100), which deforms due to pressure applied by the first and second pressing members (60)(100) to adhere to the outer circumference of the optical cable (200) and the inner circumference of the hollow part (21a) of the mounting part (21), and a fastening unit (120) that presses the first and second pressing members (60)(100) against each other to deform the sealing member (80).

The first pressing member (60) of the sealing unit (50) includes a first coupling part (70) to maintain an interlocking state, and comprises first and second unit pressing members (63)(64) forming at least one first cable insertion hole (61). The external shape of the coupled first and second unit pressing members (63)(64) may vary depending on the cross-sectional shape of the mounting part (21), and may be formed in an elliptical shape.

The first cable insertion hole (61) is formed in a direction parallel to the central axis of the mounting part (21) on the mutually opposing sides of the first and second unit pressing members (63)(64), so that the first and second unit pressing members (63)(64) form a circular hole when coupled. It is preferable that the diameter of the first cable insertion hole (61) be equal to or larger than the diameter of the optical cable connected through the junction box. The diameter and number of the first cable insertion holes (61) formed in the first and second unit pressing members (63)(64) may vary within a range that does not interfere with the first coupling part (70) and the fastening unit (120).

The first coupling part (70) comprises a first projection support (71) formed by drawing in from the top surface of the first unit pressing member (63), a first coupling projection (73) extending from the side of the first unit pressing member (63), a second projection support (75) formed by drawing in from the bottom surface of the second unit pressing member (64), and a second coupling projection (77) extending from the side of the second unit pressing member (64).

The first projection support (71) of the first unit pressing member (63) comprises a first support hole (71a) formed from the top surface of the first unit pressing member (63) with a predetermined diameter, and a first guide portion (71b) formed from the first support hole (71a) in the direction of the second unit pressing member (64) with a width smaller than the diameter of the first support hole (71a). The first coupling projection (73) comprises a first extension portion (73a) coupled to a second guide portion to be described later, and a first locking portion (73b) that is formed at the end of the first extension portion (73a) and has the same diameter as a second support hole to be described later. A first through-hole (73c) communicating with the second support hole is formed in the first locking portion (73b).

The second projection support (75) of the second unit pressing member (64) has a structure that is substantially the same as the first projection support (71), and the second coupling projection (77) has a structure that is substantially the same as the first coupling projection (73).

The second projection support (75) of the second unit pressing member (64) has a second support hole (75a) with a predetermined diameter formed from the bottom surface of the second unit pressing member (64), and a second guide portion (75b) is formed extending from the second support hole (75a) in the direction of the first unit pressing member (63) with a width smaller than the diameter of the second support hole (75a). The second coupling projection (77) comprises a second extension portion (77a) that couples to the first guide portion (71b), and a second locking portion (77b) that is formed at the end of the second extension portion (77a) and coupled to a first support hole to be described later. A second through-hole (77c) communicating with the first support hole (71a) is formed in the second locking portion (77b).

The second pressing member (100) has a structure substantially identical to the first pressing member (60), but it is further equipped with an auxiliary cable fixing part (110) formed on the lower surface of the second pressing member (100), as will be described later.

The second pressing member (100) includes a second coupling part (90) for maintaining an interlocking state, and comprises third and fourth unit pressing members (103)(104) forming at least one second cable insertion hole (101). The number of second cable insertion holes (101) formed by the third and fourth unit pressing members (103)(104) is the same as the number of first cable insertion holes (61) formed in the first pressing member (60).

The second coupling part (90) comprises a third projection support (91) formed by drawing in from the top surface of the third unit pressing member (103), a third coupling projection (93) extending from the side of the third unit pressing member (103), a fourth projection support (95) formed by drawing in from the bottom surface of the fourth unit pressing member (104). and a fourth coupling projection (97) extending from the side of the fourth unit pressing member (104).

The third projection support (91) of the third unit pressing member (103) includes a third support hole (91a) with a predetermined diameter formed from the top surface of the third unit pressing member (103), and a third guide portion (91b) that extends from the third support hole (91a) toward the fourth unit pressing member (104) with a width smaller than the diameter of the third support hole (91a). The third coupling projection (93) comprises a third extension portion (93a) that couples with the second guide portion to be described later, and a third locking portion (93b) that is formed at the end of the third extension portion (93a) and has the same diameter as the fourth support hole to be described later. A third through-hole (77c) communicating with the fourth support hole is formed in the third locking portion (93b).

The fourth projection support (95) of the fourth unit pressing member (104) has a structure substantially identical to that of the third projection support (91), and the fourth coupling projection (97) has a structure substantially identical to that of the third coupling projection (93).

The fourth projection support (95) of the fourth unit pressing member (104) includes a fourth support hole (95a) with a predetermined diameter formed from the bottom surface of the fourth unit pressing member (104), and a fourth guide portion (95b) that extends from the fourth support hole (95a) toward the third unit pressing member (103) with a width smaller than the diameter of the fourth support hole (95a). The fourth coupling projection (97) comprises a fourth extension portion (97a) that couples with the fourth guide portion, and a fourth locking portion (97b) that is formed at the end of the fourth extension portion (97a) and coupled with the third support hole. A fourth through-hole (97c) communicating with the third support hole (91a) is formed in the fourth locking portion (97b). The shapes of the third and fourth support holes (91a) (95a) and the third and fourth locking portions (93b) (97b) are not limited to being circular and can be formed in the shape of a dovetail

Meanwhile, the auxiliary cable fixing part (110) formed on the lower surface of the second pressing member (100) is for fixing the optical cable (200) introduced or extracted through the second cable insertion hole (101) of the sealing unit (50). It includes first auxiliary cable fixing pieces (112) that are extended downward from the edge of the second cable insertion hole (101) with multiple first fixing holes (111) formed.

The first auxiliary cable fixing pieces (112) are formed to extend downward from the edge of the second cable insertion hole (101). The auxiliary cable fixing part (110) further includes a band (105) for fixing the optical cable (200) that is inserted in the first and second cable fixing hole (111) formed in the first and second auxiliary cable fixing pieces (112) and introduced or extracted through the second cable insertion hole

The sealing member (80) of the sealing unit is installed between the first pressing member (60) and the second pressing member (100) and is deformed as it is compressed by the first and second pressing members (60)(100), thereby adhering closely to the inner surface of the mounting part (21) and the outer surface of the optical cable (200) supported therein to maintain water-tightness. The sealing member (80) is provided with cable gripping holes (81) corresponding to the first and second cable insertion holes (61) (101), and first and second coupling holes (85) (86) corresponding to the first and third support holes (71a) (91a) and the second and fourth support holes (75a) (95a) formed in the first and second pressing members (60)(100), respectively. The sealing member (80) is structured to adhere closely to the inner surface of the mounting part (21) and the outer surface of the optical cable (200) inserted into the cable gripping holes (81) when compressed by the first and second pressing members (60)(100). To facilitate smooth insertion of the optical cable into the cable gripping holes (81) formed in the sealing member (80), at least one slit (87) cut in the width direction of the sealing member may be formed.

The sealing member (80) is made of a flexible material that can undergo elastic deformation. The sealing member (80) may be made of silicone or soft rubber, and its shape is substantially similar to the cross-sectional shape of the mounting part (21) or the shape of the first and second pressing members (60)(100).

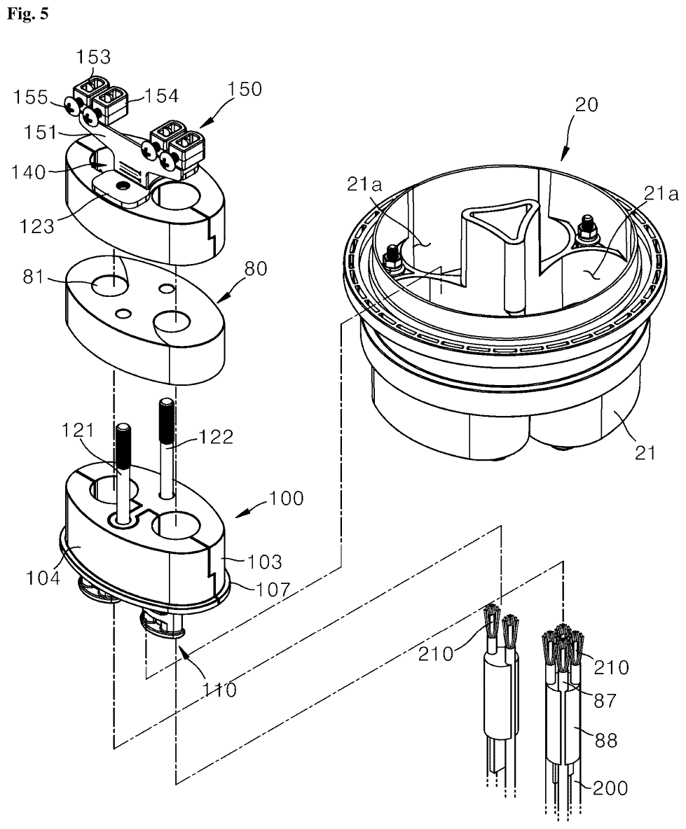

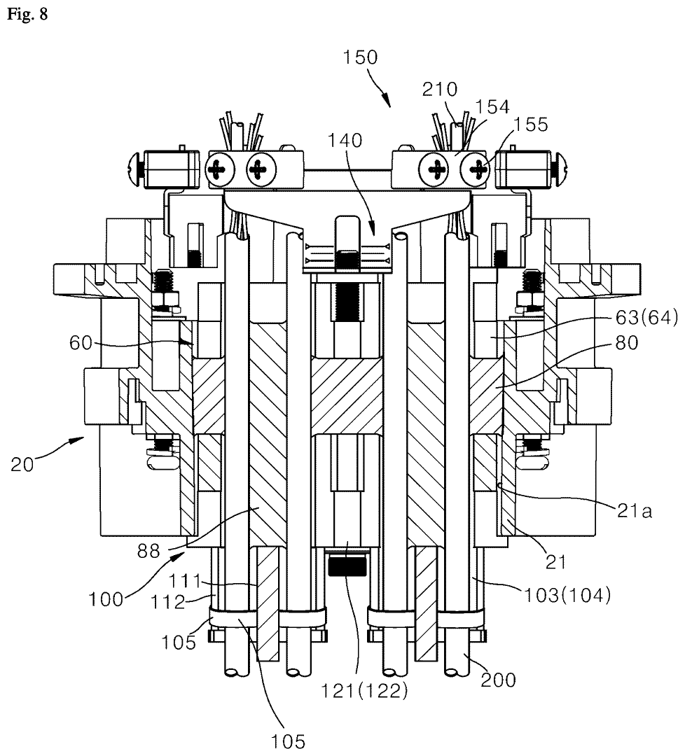

Meanwhile, as shown in FIGS. 5 and 8, if the diameter of the optical cable (200) is relatively smaller than the diameter of the cable gripping hole (81) formed in the sealing unit (80), an auxiliary sealing member (88) with auxiliary cable gripping holes (87) corresponding to the diameter of the optical cable (200) for sealing can be inserted into the cable gripping hole (81) to achieve water-tightness. The auxiliary cable gripping holes (87) may be formed in the auxiliary sealing member (88) in at least one number.

The fastening unit (120) is provided to press the sealing member (80) interposed between the first pressing member (60) and the second pressing member (100) by moving the first and second pressing members (60)(100) toward the sealing member (80), and includes fastening bolts (121) (122) penetrating the first and second pressing members (60)(100) and the sealing member (80), and fastening members (123) threadedly engaged with the fastening bolts (121) (122).

One fastening bolt (121) is inserted through the third support hole (91a), the fourth through-hole (97c) of the fourth locking portion (97b) inserted into it, the first coupling hole (85) of the sealing member, the first support hole (71a), and the second through-hole (77c) of the second locking portion (77b) coupled to it, and then is threadedly engaged with one side of the fastening member (123). The other fastening bolt (122) is inserted through the fourth support hole (95a), the third through-hole (93c) of the third locking portion coupled to it, the second coupling hole (86) of the sealing member, the first through-hole (73c) of the first locking portion (73b) coupled with the second support hole (95a), and the fourth support hole (95a), and then is threadedly engaged with the other side of the fastening member (124).

The fastening unit (120) is not limited to the above-described embodiment, and any structure capable of pressing the first and second pressing members (60)(100) toward the sealing member (80) can be applied.

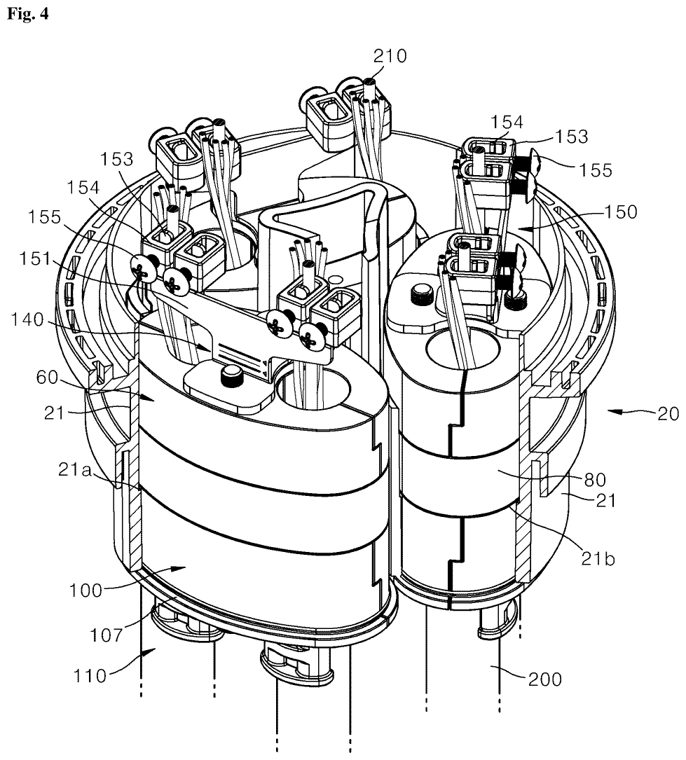

Meanwhile, as shown in FIG. 4, a protruding anti-detachment ridge (21b) for preventing the sealing unit coupled to the mounting part (21) from being separated can be formed on the inner circumferential surface of the mounting part (21). Additionally, an insertion-restriction protruding ridge (107) for preventing the sealing unit (50) from being excessively inserted into the mounting part (21) can be formed on the lower outer circumferential surface of the first pressing member (60).

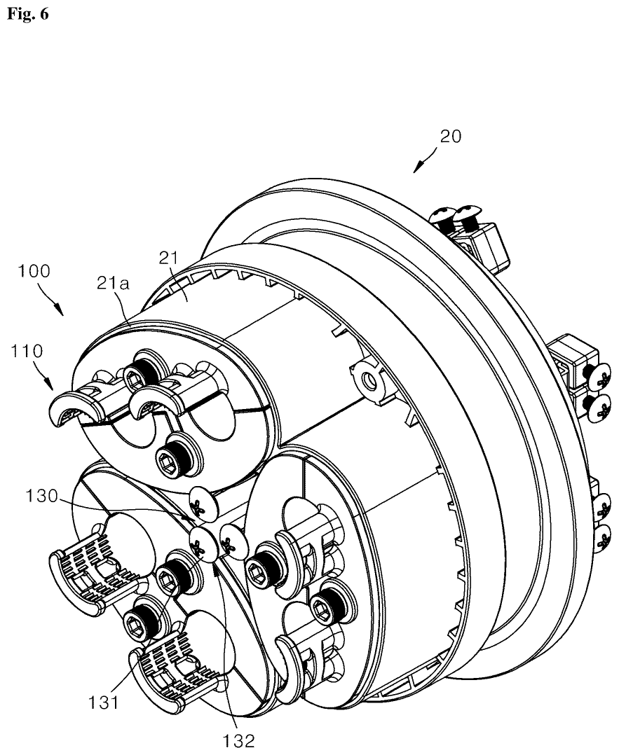

As shown in FIG. 6, the base member (20) can further include a sealing unit detachment prevention part (130) to prevent the sealing unit (50) inserted into the mounting part (21) from being separated.

The sealing unit detachment prevention part (130) include set screws (132) which can be screwed into the base member (20) around the mounting part (21). The one portion of head of the set screws (132) is in close contact with the bottom edge of the second pressing member (100).

Meanwhile, a tensile wire fixing part (150) for fixing the tensile wire of the optical cable (200) protruded toward the upper surface of the base member (20) may be further provided on the upper surface of the sealing unit (50).

The tensile wire fixing part (150) includes a cable support bracket (151) fixed to the upper surface of the first pressing member (60). Multiple coupling support portions (152) are formed on the cable support bracket (151). A tensile wire gripping member (154) having a tensile wire insertion hole (153) is inserted into each of the tensile wire fixing part (150). A fixing member (155), which is screw-coupled to the tensile wire gripping member (154) and fixes the tensile member of the optical cable (200) and the coupling support portion (150) inserted into the tensile member gripping member (154), is provided.

The base of the cable support bracket (151) is inserted and fixed to an end portion of the fastening bolts (121)(122) coupling the first and second pressing members (60)(100) and the sealing member (80) in the same manner as the fastening members (123). The base of the cable support bracket (151) may be supported by the fastening members (123).

The cable support bracket (151) is provided with a sealing member deformation limit indicator (140) for displaying the compressing limit of the sealing member using the position at which the ends of the fastening bolts (121)(122) protrude. The sealing member deformation limit indicator (140) indicates the upper and lower limits of the sealing force considering the water-tight performance due to the deformation force of the sealing member (80).

The cable fixing part is not limited to the above-described embodiment, and can be installed on the lower side of the support frame (12), i.e., the upper surface of the base member (20) adjacent to the support frame (12). In this case, although not shown in the figures, the cable fixing part includes a fixing plate fixed to the support frame. Multiple cable fixing parts are formed on the front side of the fixing plate for fixing the optical cable (200) introduced through the sealing unit. The cable fixing part is provided with an insertion part into which the optical cable (200) is inserted, and clip fixing parts for coupling cable fixing clips to fix the optical cable (200) using screws are formed on both sides of the insertion portion.

In the dome-type mechanical optical cable junction box according to the present invention, the optical fibers of the optical cables (200) supported by the sealing units (50) coupled to the mounting part (21) of the base member (20) are connected using the splice trays (11) supported by the frame (12).

The dome-type mechanical optical cable junction box (10) forms an air-tight space blocked from the external environment by coupling the base member (20) and the cover (40) using clamps, and maintains water-tightness between the optical cables (200) and the mounting part (21) using the sealing units (50) inserted into the mounting part (21) in a supported state.

Additionally, since the optical cables (200) are fixed by the tensile wire fixing part (150) and the auxiliary cable fixing part (110) installed on the sealing unit (50), the optical cables (200) are prevented from being separated from the junction box by the pulling external force applied to the optical cables (200). Moreover, disconnection of the optical fibers connected using the splice trays is also prevented.

In more detail, the sealing unit (50) for maintaining air-tightness during the entering and exiting of the optical cables (200) is pre-assembled using the first pressing member (60) coupled by the first and second unit pressing members (63)(64), the second pressing member (100) coupled by the third and fourth unit pressing members (103)(104), and the sealing member (80) interposed therebetween using the fastening part (120). In this state, the optical cable (200) for connection is inserted through the second cable insertion hole (101) of the second pressing member (100), the cable gripping hole (81) of the sealing member (80), and the first cable insertion hole (61) of the first pressing member (60).

The above embodiment is not limited, and the optical cable (200) can be inserted into the first pressing member (60), the sealing member (80), and the second pressing member (100) independently. The insertion of the optical cable into the first pressing member (60) and the second pressing member (100) can be achieved with the first and second unit pressing members (63)(64) and the third and fourth unit pressing members (103)(104) being separated.

At this time, the coupling of the first and second unit pressing members (63)(64) forming the first pressing member (60) are achieved by the engagement of the first coupling projection (73) with the second projection support portion (75) and the engagement of the second coupling projection (77) with the first projection support (71). The ends of the first and second coupling projections (73) (77) are formed in a cylindrical shape to be inserted into the first and second projection support (71) (75) without detachment, thereby enhancing the coupling support force.

The coupling of the third and fourth unit pressing members (103)(104) forming the second pressing member (100) are achieved by the engagement of the third coupling projection (93) with the fourth projection support (95) and the engagement of the fourth coupling projection (97) with the third projection support portion (91).

The above-described sealing units (50), coupled with the optical cables (200), are inserted into each of the mounting part (21). At this time, the insertion-restriction protruding ridge (107) should be tightly attached to the edge of the mounting part (21) of the base member (20). When the insertion of the sealing unit (50) into the mounting part (21) is completed, the fastening bolts (121)(122) of the fastening unit (120) are tightened, causing the first and second pressing members (60)(100) to move toward the sealing member (80) and compress the sealing member (80).

When compressed as described above, the outer circumferential surface of the deformed sealing member (80) adheres to the inner circumferential surface of the mounting part (21) and, simultaneously, the inner circumferential surface of the cable gripping hole (81) of the sealing member (80) adheres to the outer circumferential surface of the optical cable (200) inserted into the cable gripping hole (81).

The adhesion force between the inner circumferential surface of the mounting part (21), the outer circumferential surface of the optical cable (200), and the sealing member (80) increases as the pressing force of the first and second pressing members (60)(100) by the fastening unit (120) increases.

Once the fixation of the sealing unit (50) is completed as described above, the tensile wire of the optical cable (200) is fixed using the tensile wire fixing part (150). To fix the tensile wire of the optical cable (200) using the tensile wire fixing part (150), the tensile wire (210) of the optical cable (200) is inserted into the tensile wire gripping member (154) coupled to the coupling support portion (152) of the cable support bracket (151), and a tensile wire gripping member (153) is fixed using the screw-coupled fixing member (154).

Furthermore, the lower part of the optical cable (200) is fixed using the band (105) and the fixing holes of the auxiliary cable fixing part (110) formed on the lower surface of the second pressing member (100).

When the optical cable (200) is pulled by an external force in this state, the optical cable (200) is fixed to the sealing unit (50) by the cable fixing part (150) and the auxiliary cable fixing part (110) installed on the sealing unit (50). The sealing member (80) of the sealing unit (50) deforms and is supported by the protruding anti-detachment ridge (21b) formed on the inner circumferential surface of the mounting part (21), thereby preventing separation of both the optical cable and the sealing unit (50).

Moreover, since the set screws (132) of the sealing unit detachment prevention part (130) are screw-coupled to the base member (20) with a portion of the head portion (131) of the set screws (132) pressing against the bottom edge of the second pressing member (100) of the sealing unit (50) inserted into the mounting part (21), the sealing unit (50) is prevented from detaching from the mounting part (21).

In another embodiment shown in FIG. 8, if the diameter of the optical cable (200) is smaller than the diameter of the cable gripping holes (81) (82) formed in the sealing member (80), an auxiliary sealing member (88) is inserted into the cable gripping holes (81) (82) with the optical cable (200) being supported in the auxiliary cable gripping holes (87).

Then, as described above, the first and second pressing members (60)(100) are pressed toward the sealing member (80) using the fastening bolts of the fastening unit. As a result, the sealing member (80) is deformed, and the outer circumferential surface of the sealing member adheres to the inner circumferential surface of the mounting portion (21), and the area around the cable gripping holes (81) of the sealing member (80) adheres to the outer circumferential surface of the auxiliary sealing member (88), pressing against it. Furthermore, the inner circumferential surface of the auxiliary cable gripping holes (87) of the auxiliary sealing member (88) adheres to the outer circumferential surface of the optical cable (200), thereby maintaining an air-tight seal

As described above, the sealing unit (50) can accommodate cables with various diameters, specifically, optical cables with diameters smaller than the diameter of the cable gripping hole (81), and can maintain air-tightness.

As explained above, the dome-type mechanical optical cable junction box according to the present invention can enhance air-tightness when cables are inserted and extracted through the partitioned internal space, and can prevent damage to the cable connection portions caused by tension applied due to external forces.

Although the present invention has been described with reference to the embodiments shown in the drawings, these are merely examples, and those skilled in the art will understand that various modifications and equivalent alternative embodiments are possible. Therefore, the true technical protection scope of the present invention should be defined by the technical spirit of the appended patent claims.

1. A dome-type mechanical optical cable junction box comprising:
a base member including a support frame on which splice trays for connecting optical cables are installed, and a plurality of mounting parts through which cables pass for cable entry and exit, supporting the support frame;
a cover member coupled to the base member, enclosing the support frame to maintain air-tightness; and
a sealing unit coupled to each mounting part of the base member, encasing the cable and maintaining air-tightness with the exterior, and having at least one cable fixing part fixing the cable.

2. The dome-type mechanical optical cable junction box of claim 1, wherein:
the sealing unit is inserted into the mounting part of the base member, and comprises:
a first pressing member having a first coupling part to maintain an interlocking state, and including first and second unit pressing members forming at least one first cable insertion hole;
a second pressing member having a second coupling part to maintain an interlocking state, and including third and fourth unit pressing members forming at least one second cable insertion hole;
a sealing member interposed between the first and second pressing members, having cable gripping holes formed corresponding to the first and second cable insertion holes; and
a fastening unit that presses the first and second pressing members toward the sealing member, causing the sealing member to be deformed and closely adhere to the outer circumference of the cable and the inner circumference of the mounting part.

3. The dome-type mechanical optical cable junction box of claim 2, wherein:
the first coupling part comprises a first projection support formed by drawing in from the top surface of the first unit pressing member, a first coupling projection extending from the side of the first unit pressing member, a second projection support formed by drawing in from the bottom surface of the second unit pressing member, and a second coupling projection extending from the side of the second unit pressing member;
and the second coupling part comprises a third projection support formed by drawing in from the top surface of the third unit pressing member, a third coupling projection extending from the side of the third unit pressing member, a fourth projection support formed by drawing in from the bottom surface of the fourth unit pressing member, and a fourth coupling projection extending from the side of the fourth unit pressing member.

4. The dome-type mechanical optical cable junction box of claim 3, wherein:
the first projection support of the first unit pressing member comprises a first support hole with a predetermined diameter formed from the top surface of the first unit pressing member, and a first guide portion extending from the first support hole toward the second unit pressing member with a width smaller than the diameter of the first support hole;
the first coupling projection comprises a first extension portion extending from the first unit pressing member toward the second unit pressing member, and a first locking portion formed at the end of the first extension portion with a first through-hole;
the second projection support of the second unit pressing member comprises a second support hole with a predetermined diameter formed from the bottom surface of the second unit pressing member, and a second guide portion extending from the second support hole toward the first unit pressing member with a width smaller than the diameter of the first support hole;
and the second coupling projection comprises a second extension portion coupled to the first guide portion, and a second locking portion formed at the end of the second extension portion with a second through-hole.

5. The dome-type mechanical optical cable junction box of claim 1, wherein:
the cable fixing part includes a tensile wire fixing part installed in the first pressing member to secure the tensile wire of the cable;
and the tensile wire fixing part comprises a cable support bracket installed on the first pressing member and having multiple coupling support portions, a tensile wire gripping member inserted in the coupling support portion of the cable support bracket and having a tensile wire insertion portion for the cable, and a fixing member screw-coupled to the tensile wire gripping member to secure the coupling support portion and the tensile wire.

6. The dome-type mechanical optical cable junction box of claim 3, wherein:
the cable fixing part includes a first auxiliary cable fixing part extending from the lower surface of at least one side of the third and fourth unit pressing members and having a plurality of first fixing holes, and the auxiliary cable gripping part having at least one band that fixes the cable supported by the auxiliary cable fixing part.

7. The dome-type mechanical optical cable junction box of claim 2, wherein:
a protruding anti-detachment ridge is formed on the inner circumference of the mounting part corresponding to the inserted sealing member to prevent the sealing unit from detaching.

8. The dome-type mechanical optical cable junction box of claim 1, wherein:
the base member installed in the mounting part is further provided with a sealing unit detachment prevention part to prevent the detachment of the sealing unit inserted into the mounting part;
and the sealing unit detachment prevention part includes set screws, which are screw-coupled to the base member around the mounting part, and a portion of the head of the set screws is in close contact with the bottom edge of the second pressing member to prevent the detachment of the sealing unit.

9. The dome-type mechanical optical cable junction box of claim 1, wherein:
the sealing member is made of soft synthetic resin or rubber, with cable gripping holes formed corresponding to the first and second cable gripping holes, and the sealing unit is provided with at least one slit formed in the width direction to allow the cable gripping holes to open.

10. The dome-type mechanical optical cable junction box of claim 1, wherein:
an auxiliary sealing member with auxiliary cable gripping holes corresponding to the diameter of the cable for sealing is inserted into the cable gripping hole so that water-tightness is achieved by pressing the auxiliary sealing member and the cable when the sealing member is compressed.

11. The dome-type mechanical optical cable junction box of claim 1, wherein:
the cable support bracket is provided with a scaling member deformation limit indicator that shows the compression limit of the scaling member using the position where the end of the fastening bolt protrudes.
